(19) United States
(12) Patent Application Publication
(10) Pub. No.: US 2025/0141822 A1
(43) Pub. Date: May 1, 2025

(54) ANTI-SPAM ARTIFICIAL INTELLIGENCE SERVICE

(71) Applicant: T-MOBILE INNOVATIONS LLC, Overland Park, KS (US)

(72) Inventor: Chingming CHAO, Bellevue, WA (US)

(21) Appl. No.: 18/499,912

(22) Filed: Nov. 1, 2023

(51) Int. Cl. H04L 51/212; H04L 51/58

(52) U.S. Cl. CPC H04L 51/212; H04L 51/58

(57) ABSTRACT

Systems and methods are provided for providing an anti-spam artificial intelligence service. Initially, a message is received at a user equipment (UE) corresponding to a user. Text corresponding to the message is forwarded to an anti-spam engine to determine if the message is spam. A response is received, at the UE, from the anti-spam engine. The user is prompted, at the UE, to select an action to perform corresponding to the message. In various aspects, the action is to ignore, delete, or read the message.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for providing an anti-spam artificial intelligence (AI) service. More particularly, in aspects set forth herein, a user is able to leverage the anti-spam AI service to further inspect a text message to determine if it is safe to open the message or any links or files contained within the message. Initially, a message is received at a user equipment (UE) corresponding to a user. Text corresponding to the message is forwarded to an anti-spam engine to determine if the message is spam. A response is received, at the UE, from the anti-spam engine. The user is prompted, at the UE to select an action to perform corresponding to the message. In various aspects, the recommendation is to ignore, delete, or read the message.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed;

FIG. 2 illustrates an example anti-spam engine, in accordance with aspects herein;

FIGS. 3-9 depict illustrative screen displays providing responses from the anti-spam artificial intelligence service, in accordance with aspects herein;

FIG. 10 depicts a flow diagram of a method for providing an anti-spam artificial intelligence service, in accordance with aspects herein; and

FIG. 11 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

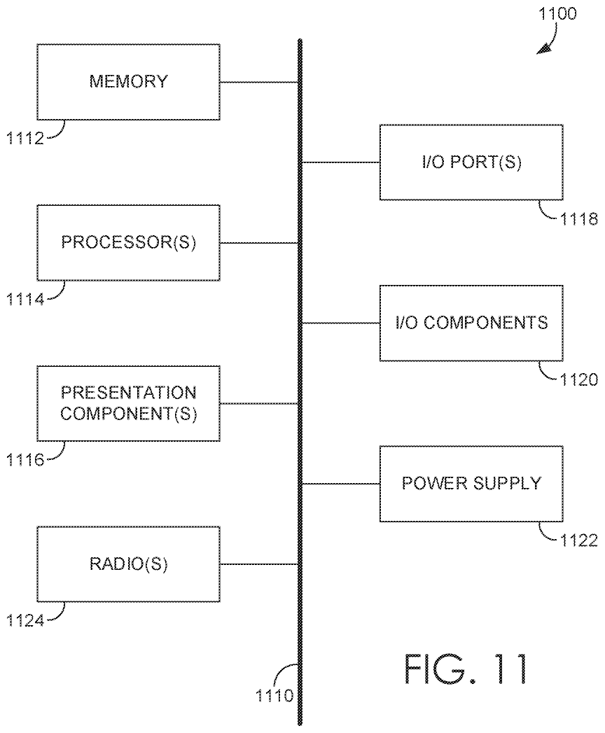

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 1100 described herein with respect to FIG. 11.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

Conventional mobile communications network systems facilitate billions of Short Messaging Service (SMS) messages being communicated on a daily basis. Although attempts are made to block spam messages, millions of spam messages are still being received daily by users. In many situations, spam messages are being communicated for nefarious purposes. For example, spam messages are sometimes communicated to entice users to provide confidential information or to click on malicious links or files. Even when potential spam messages are flagged by services utilized or provided by conventional mobile communications network systems, it is often done so in an ambiguous manner such as by indicating the message is “Spam Likely.” As a result, it is unclear to the user how to proceed. Moreover, bandwidth and other network resources are wasted delivering and activating harmful spam messages.

The present disclosure is directed to systems, methods, and computer readable media for providing an anti-spam AI service. More particularly, in aspects set forth herein, a user is able to leverage the anti-spam AI service to further inspect a text message to determine if it is safe to open the message or any links or files contained within the message. Initially, the user receives a message at the UE. If the user is unsure of the origin or the integrity of the message, the user is able to text corresponding to the message to an anti-spam engine to determine if the message or its contents are safe. In response, the anti-spam engine returns a recommendation to the user and prompts the user to select an action to perform for the message. For example, the user can select to ignore, delete, or read the message.

A first aspect of the present disclosure is directed to a method for providing an anti-spam artificial intelligence service. A message is received at a UE corresponding to the user. Text corresponding to the message is forwarded to an anti-spam engine to determine if the message is spam. A response is received, at the UE, from the anti-spam engine. The user is prompted, at the UE, to select an action to perform corresponding to the message.

A second aspect of the present disclosure is directed to a non-transitory computer storage media storing computer-usable instructions that when used by one or more processors, cause the one or more processors to perform operations. The operations comprise receiving a message at a UE corresponding to a user. The operations also comprise forwarding text corresponding to the message to an anti-spam engine to determine if the message is spam. The operations further comprise receiving, at the UE, a response from the anti-spam engine. The operations also comprise prompting the user, at the UE, to select an action to perform corresponding to the message.

Another aspect of the present disclosure is directed to a system for providing an anti-spam artificial intelligence service. The system comprises: a node configured to wirelessly communicate with a UE and an anti-spam engine; and the UE. The UE is configured to: receive a message; forward text corresponding to the message to the anti-spam engine to determine if the message is spam; receive a response from the anti-spam engine; and prompt a user corresponding to the UE to select an action to perform corresponding to the message.

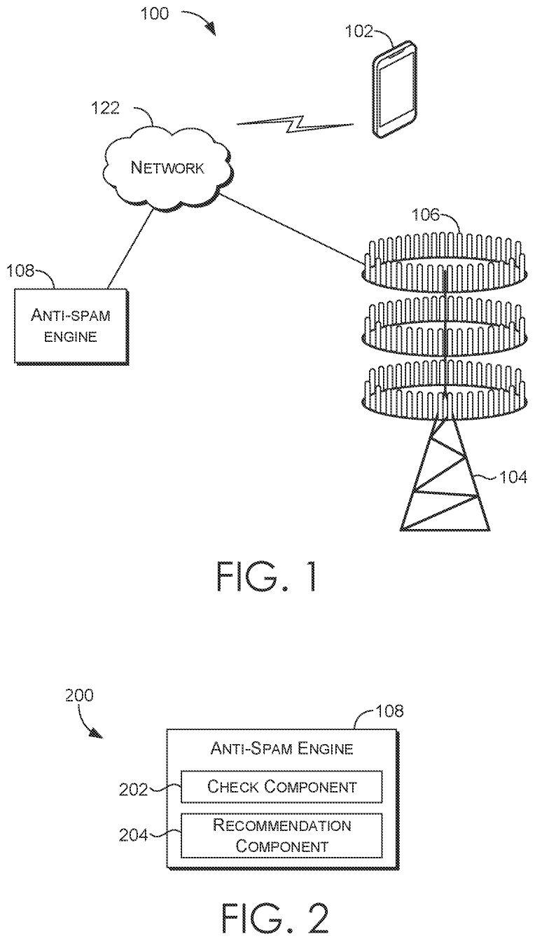

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 1100 described with respect to FIG. 11, and a network. As shown in FIG. 1, a communications device may be a UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize network 122 to communicate with other computing devices (e.g., mobile device(s), a server(s), a personal computer(s), etc.). In embodiments, network 122 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 122 may include multiple networks, as well as being a network of networks, but is shown in more simple form so as to not obscure other aspects of the present disclosure. Network 122 may be part of a telecommunications network that connects subscribers to their immediate service provider. In embodiments, network 122 is associated with a telecommunications provider that provides services to user devices, such as UE 102. For example, network 122 may provide voice services to user devices or corresponding users that are registered or subscribed to utilize the services provided by a telecommunications provider. Although it is contemplated network 122 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), or the like, network 122 is depicted in FIG. 1 as a 5G network.

The network environment 100 may include a database (not shown). The database may be similar to the memory component 1112 in FIG. 11 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, the UE 102 may communicate with other devices by using a base station, such as base station 104. In embodiments, base station 104 is a wireless communications station that is installed at a fixed location, such as at a radio tower, as illustrated in FIG. 1. The radio tower may be a tall structure designed to support one or more antennas 106 for telecommunications and/or broadcasting. In other embodiments, base station 104 is a mobile base station. The base station 104 may be an MMU and include gNodeB for mMIMO/5G communications via network 122. In this way, the base station 104 can facilitate wireless communication between UE 102 and network 122.

As stated, the base station 104 may include a radio (not shown) or a remote radio head (RRH) that generally communicates with one or more antennas associated with the base station 104. In this regard, the radio is used to transmit signals or data to an antenna 106 associated with the base station 104 and receive signals or data from the antenna 106. Communications between the radio and the antenna 106 can occur using any number of physical paths. A physical path, as used herein, refers to a path used for transmitting signals or data. As such, a physical path may be referred to as a radio frequency (RF) path, a coaxial cable path, cable path, or the like.

The antenna 106 is used for telecommunications. Generally, the antenna 106 may be an electrical device that converts electric power into radio waves and converts radio waves into electric power. The antenna 106 is typically positioned at or near the top of the radio tower as illustrated in FIG. 1. Such an installation location, however, is not intended to limit the scope of embodiments of the present invention. The radio associated with the base station 104 may include at least one transceiver configured to receive and transmit signals or data.

Continuing, the network environment 100 may further include an anti-spam engine 108. The anti-spam engine 108 may be configured to, among other things, receive text corresponding to a message to determine if the message is spam and provide a response to the user indicating if the message is spam, in accordance with the present disclosure. Though anti-spam engine 108 is illustrated as a standalone device (e.g., a server having one or more processors) in FIG. 1., it may be a component of base station 104 in FIG. 1, a component of the UE 102, a service provided via the network 122, or may be remotely located.

Referring now to FIG. 2, the anti-spam engine 108 may include, among other things, check component 202 and recommendation component 204. The anti-spam engine 108 may receive, among other things, text corresponding to messages from user devices, such as UE 102, within a network cell associated with a base station 104. For example, a user may receive a text message from an unknown source or one that includes suspicious attachments or links. The user may wish to confirm the text message is legitimate. To do so, the user may select the message or a portion of the message (i.e., text included in the message, an attachment included in the message, a link included in the message, or a combination thereof) to send to the anti-spam engine 108. In aspects, the anti-spam engine 108 is an AI-powered language model capable of generating a human-like response based on the message or a portion of the message selected by the user for analysis. Examples of such AI-powered language models include, but are not limited to, OPENAI GPT, GOOGLE LAMDA, MICROSOFT BING AI, DEEPMIND SPARROW, ANTHROPIC CLAUDE 2, GOOGLE BARD, META LLAMA, MICROSOFT NVIDIA MEGATRON-TURING, GPT 3.5/4 (text) CHAT COMPLETIONS (conversation) DALL-E2 (image) WHISPER (transcription and translation), and AWS SAGEMAKER.

Check component 202 generally receives text corresponding to a message (or a portion of the message) the user has selected to communicate to the anti-spam engine 108. Check component 202 leverages the AI-powered language model by providing the message or a portion of the message as input. The AI-powered language model is trained to analyze the message or the portion of the message to determine if the message is spam.

Recommendation component 204 generally provides a response to the user based on the analysis of the message or the portion of the message. In aspects, recommendation component 204 determines the message is spam, is not spam, or may be spam. Accordingly, recommendation component 204 prompts the user to select an action to perform corresponding to the message. The action may be to ignore, delete, or read the message. Recommendation component 204 may also solicit feedback from the user that can be utilized to further train the AI-powered language model.

In one aspect, the text corresponding to the message may initially be forwarded to a server. The server is instructed to make an API call to the anti-spam engine. The API call includes the text corresponding to the message. In another aspect a selection made by the user causes text corresponding to the message to be initially forwarded to a cybersecurity service. If the cybersecurity service is unable to determine if the text corresponding to the message is spam, the cybersecurity service is instructed to make API call to the anti-spam engine. The API call includes the text corresponding to the message.

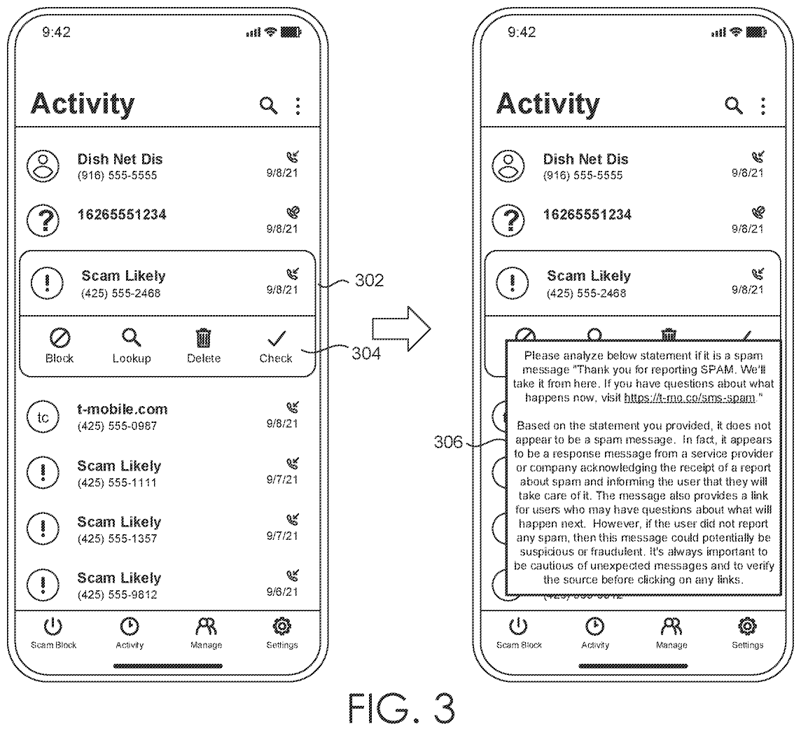

With reference to FIGS. 3-9, illustrative screen displays according to aspects of the present invention are shown. The screen displays may appear in any order and with any number of screen displays, without regard to whether the screen display is described or depicted herein. The screen displays comprise example responses from the anti-spam artificial intelligence service, in accordance with aspects herein.

As shown in FIG. 3, the user has received a message from a number identified by the service provider as “Scam Likely” 302. The user may be presented various options to “Block,” “Lookup,” “Delete,” or “Check” the corresponding message. Upon the user selecting “Check” 304, the corresponding text or a portion of the text (which may include attachments or links) is communicated to the anti-spam engine. For example, the corresponding text may be “Thank you for reporting SPAM. We'll take it from here. If you have questions about what happens now, visit https://t-mo.co/sms-spam.”

After analyzing the text, the anti-spam engine communicates a response 306 back to the UE. The response 306 may include identification of the text or the portion of the text being analyzed, as well as a recommendation. For example, the response may be “Based on the statement you provided, it does not appear to be a spam message. In fact, it appears to be a response message from a service provider or company acknowledging the receipt of a report about spam and informing the user that they will take care of it. The message also provides a link for users who may have questions about what will happen next. However, if the user did not report any spam, then this message could potentially be suspicious or fraudulent. It's always important to be cautious of unexpected messages and to verify the source before clicking on any links.” Based on the recommendation, the user may select to block the sender, delete the message, ignore the message, or read the message.

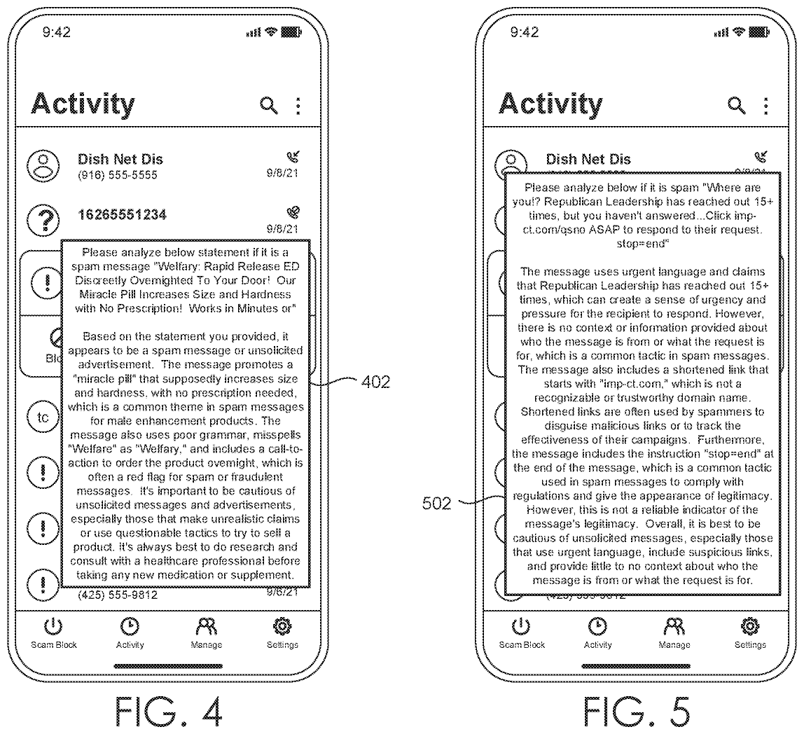

Referring now to FIG. 4, in another example, the text may be “Welfary: Rapid Release ED Discreetly Overnighted To Your Door! Our Miracle Pill Increases Size and Hardness with No Prescription! Works in Minutes or.” The anti-spam engine may communicate a response 402 back to the UE that reads “Based on the statement you provided, it appears to be a spam message or unsolicited advertisement. The message promotes a ‘miracle pill’ that supposedly increases size and hardness, with no prescription needed, which is a common theme in spam messages for male enhancement products. The message also uses poor grammar, misspells ‘Welfare’ as ‘Welfary,’ and includes a call-to-action to order the product overnight, which is often a red flag for spam or fraudulent messages. It's important to be cautious of unsolicited messages and advertisements, especially those that make unrealistic claims or use questionable tactics to try to sell a product. It's always best to do research and consult with a healthcare professional before taking any new medication or supplement.”

In FIG. 5, in another example, the text may be “Where are you!? Republican Leadership has reached out 15+ times, but you haven't answered . . . Click imp-ct.com/qsno ASAP to respond to their request. stop-end.” The anti-spam engine may communicate a response 502 back to the UE that reads “The message uses urgent language and claims that Republican Leadership has reached out 15+ times, which can create a sense of urgency and pressure for the recipient to respond. However, there is no context or information provided about who the message is from or what the request is for, which is a common tactic in spam messages. The message also includes a shortened link that starts with ‘imp-ct.com,’ which is not a recognizable or trustworthy domain name. Shortened links are often used by spammers to disguise malicious links or to track the effectiveness of their campaigns. Furthermore, the message includes the instruction ‘stop-end’ at the end of the message, which is a common tactic used in spam messages to comply with regulations and give the appearance of legitimacy. However, this is not a reliable indicator of the message's legitimacy. Overall, it is best to be cautious of unsolicited messages, especially those that use urgent language, include suspicious links, and provide little to no context about who the message is from or what the request is for.”

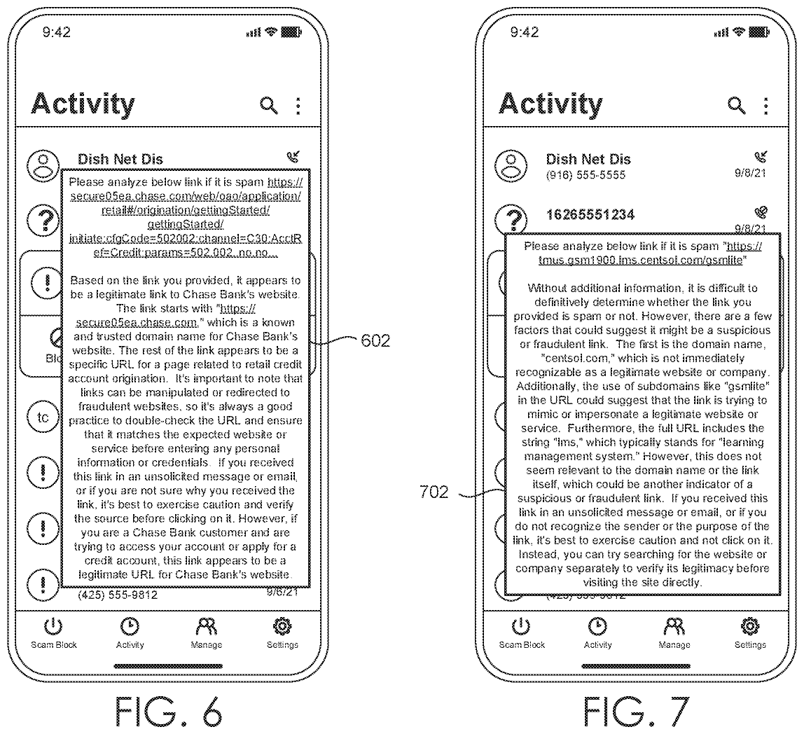

In another example, as shown in FIG. 6, the text may be a link “https://secure05ea.chase.com/web/oao/application/retail #/origination/gettingStarted/gettingStarted/initiate;cfgCode=502002;channel=C30;AcctRef=Credit;params=502,002,,no,no,,,” The anti-spam engine may provide as a response 602 “Based on the link you provided, it appears to be a legitimate link to Chase Bank's website. The link starts with ‘https://secure05ea.chase.com,’ which is a known and trusted domain name for Chase Bank's website. The rest of the link appears to be a specific URL for a page related to retail credit account origination. It's important to note that links can be manipulated or redirected to fraudulent websites, so it's always a good practice to double-check the URL and ensure that it matches the expected website or service before entering any personal information or credentials. If you received this link in an unsolicited message or email, or if you are not sure why you received the link, it's best to exercise caution and verify the source before clicking on it. However, if you are a Chase Bank customer and are trying to access your account or apply for a credit account, this link appears to be a legitimate URL for Chase Bank's website.

Turning another now to FIG. 7, the text may be link “https://tmus.gsm1900.lms.centsol.com/gsmlite.” As a response 702, the anti-spam engine may indicate “Without additional information, it is difficult to definitively determine whether the link you provided is spam or not. However, there are a few factors that could suggest it might be a suspicious or fraudulent link. The first is the domain name, ‘centsol.com,’ which is not immediately recognizable as a legitimate website or company. Additionally, the use of subdomains like ‘gsmlite’ in the URL could suggest that the link is trying to mimic or impersonate a legitimate website or service. Furthermore, the full URL includes the string ‘lms,’ which typically stands for ‘learning management system.’ However, this does not seem relevant to the domain name or the link itself, which could be another indicator of a suspicious or fraudulent link. If you received this link in an unsolicited message or email, or if you do not recognize the sender or the purpose of the link, it's best to exercise caution and not click on it. Instead, you can try searching for the website or company separately to verify its legitimacy before visiting the site directly.”

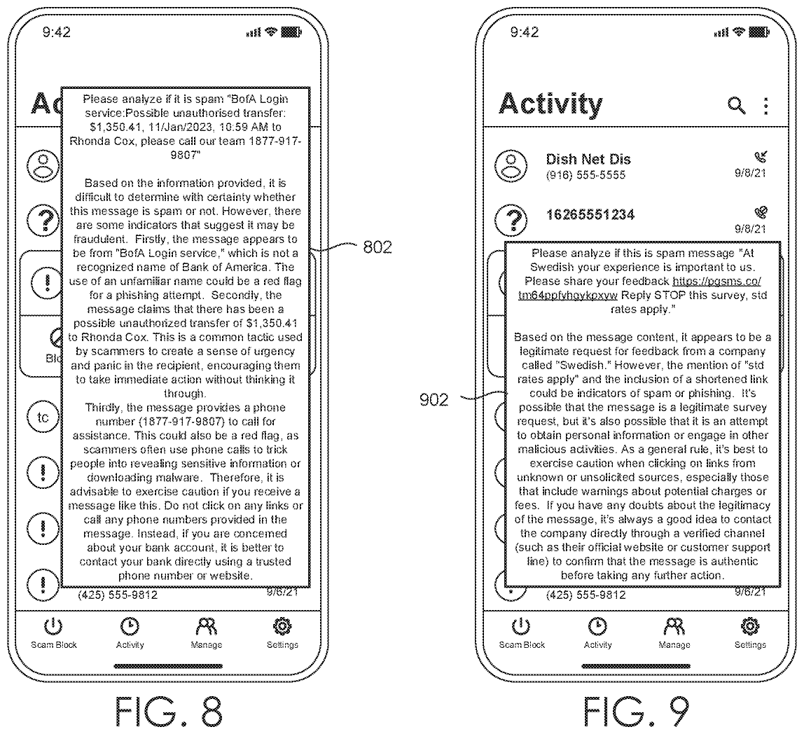

Referring to FIG. 8, the text may be “BofA Login service: Possible unauthorised transfer: $1,350.41, 11/Jan/2023, 10:59 AM to Rhonda Cox, please call our team 1877-917-9807.” After analysis, the anti-spam engine may provide the response 802 “Based on the information provided, it is difficult to determine with certainty whether this message is spam or not. However, there are some indicators that suggest it may be fraudulent. Firstly, the message appears to be from ‘BofA Login service,’ which is not a recognized name of Bank of America. The use of an unfamiliar name could be a red flag for a phishing attempt. Secondly, the message claims that there has been a possible unauthorized transfer of $1,350.41 to Rhonda Cox. This is a common tactic used by scammers to create a sense of urgency and panic in the recipient, encouraging them to take immediate action without thinking it through. Thirdly, the message provides a phone number (1877-917-9807) to call for assistance. This could also be a red flag, as scammers often use phone calls to trick people into revealing sensitive information or downloading malware. Therefore, it is advisable to exercise caution if you receive a message like this. Do not click on any links or call any phone numbers provided in the message. Instead, if you are concerned about your bank account, it is better to contact your bank directly using a trusted phone number or website.”

As shown in FIG. 9, the text may be “At Swedish your experience is important to us. Please share your feedback https://pgsms.co/tm64ppfyhgykpxyw Reply STOP this survey, std rates apply.” The anti-spam engine may communicate the response 306 “Based on the message content, it appears to be a legitimate request for feedback from a company called ‘Swedish.’ However, the mention of ‘std rates apply’ and the inclusion of a shortened link could be indicators of spam or phishing. It's possible that the message is a legitimate survey request, but it's also possible that it is an attempt to obtain personal information or engage in other malicious activities. As a general rule, it's best to exercise caution when clicking on links from unknown or unsolicited sources, especially those that include warnings about potential charges or fees. If you have any doubts about the legitimacy of the message, it's always a good idea to contact the company directly through a verified channel (such as their official website or customer support line) to confirm that the message is authentic before taking any further action.”

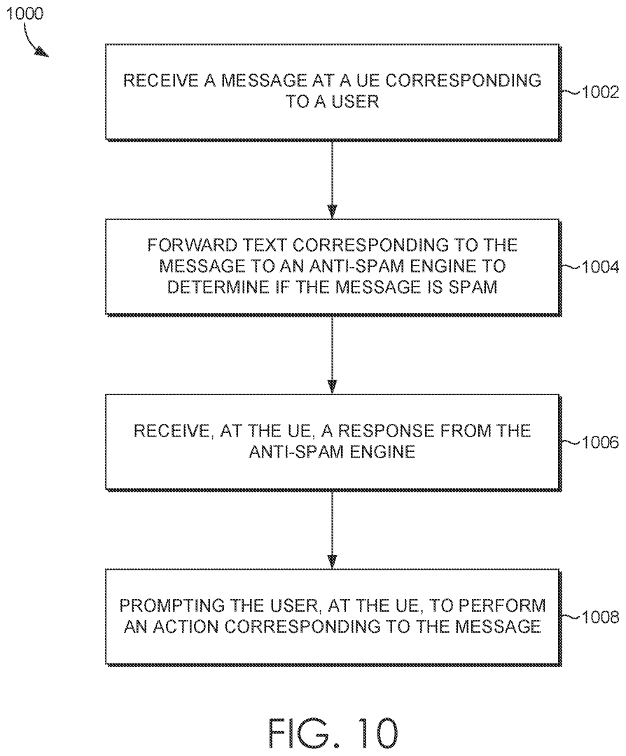

Referring to FIG. 10, a flow diagram is provided depicting a method 1000 for providing an anti-spam artificial intelligence service, in accordance with aspects of the present invention. Method 1000 may be performed by any computing device (such as computing device described with respect to FIG. 11) with access to an anti-spam engine (such as the one described with respect to FIGS. 1 and 2) or by one or more components of the network environment described with respect to FIG. 1 (such as UE 102, access point 104, or anti-spam engine 108).

At step 1002, a message is received at a UE corresponding to a user. For example, the message may be a SMS message the user receives from another user. If the user does not recognize a number associated with the sender of the message or the message appears suspicious (e.g., an unexpected attachment or a link to a website), the user may be hesitant to open the message, open the attachment, or follow the link. Even though the user or network provider may subscribe to a cybersecurity service or similar spam detection service, the message may only be flagged as a possible spam message and the user may be unsure how to proceed.

Accordingly, at step 1004, text corresponding to the message is forwarded to an anti-spam engine to determine if the message is spam. For example, the user may select to check the message in situations where the user is uncertain. By doing so, the text of the message can be analyzed by the anti-spam engine. In one aspect, a selection made by the user is received at the UE that causes text corresponding to the message to be forwarded directly to the anti-spam engine. In another aspect, a selection made by the user causes text corresponding to the message to be initially forwarded to a server. The server is instructed to make an API call to the anti-spam engine. The API call includes the text corresponding to the message. In yet another aspect a selection made by the user causes text corresponding to the message to be initially forwarded to a cybersecurity service. If the cybersecurity service is unable to determine if the text corresponding to the message is spam, the cybersecurity service is instructed to make API call to the anti-spam engine. The API call includes the text corresponding to the message.

At step 1006, a response is received, at the UE, from the anti-spam engine. In some aspects, the response may indicate the message is a scam message. In other aspects, the response may indicate the message is a safe message. In either case, at step 1008, the user is prompted, at the UE, to perform an action corresponding to the message. For example, in various aspects, the action may be to ignore, delete, or read the message.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 11, a block diagram of an exemplary computing device 1100 suitable for use in implementations of the technology described herein is provided. In particular, the exemplary computer environment is shown and designated generally as computing device 1100. Computing device 1100 is but one example of a suitable computing environment and is not intended to suggest any limitation as to the scope of use or functionality of the invention. Neither should computing device 1100 be interpreted as having any dependency or requirement relating to any one or combination of components illustrated. It should be noted that although some components in FIG. 11 are shown in the singular, they may be plural. For example, the computing device 1100 might include multiple processors or multiple radios. In aspects, the computing device 1100 may be a UE/WCD, or other user device, capable of two-way wireless communications with an access point. Some non-limiting examples of the computing device 1100 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 11, computing device 1100 includes a bus 1110 that directly or indirectly couples various components together, including memory 1112, processor(s) 1114, presentation component(s) 1116 (if applicable), radio(s) 1124, input/output (I/O) port(s) 1118, input/output (I/O) component(s) 1120, and power supply(s) 1122. Although the components of FIG. 11 are shown with lines for the sake of clarity, in reality, delineating various components is not so clear, and metaphorically, the lines would more accurately be grey and fuzzy. For example, one may consider a presentation component such as a display device to be one of I/O components 1120. Also, processors, such as one or more processors 1114, have memory. The present disclosure hereof recognizes that such is the nature of the art, and reiterates that FIG. 11 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 1112 may take the form of memory components described herein. Thus, further elaboration will not be provided here, but it should be noted that memory 1112 may include any type of tangible medium that is capable of storing information, such as a database. A database may be any collection of records, data, and/or information. In one embodiment, memory 1112 may include a set of embodied computer-executable instructions that, when executed, facilitate various functions or elements disclosed herein. These embodied instructions will variously be referred to as “instructions” or an “application” for short.

Processor 1114 may actually be multiple processors that receive instructions and process them accordingly. Presentation component 1116 may include a display, a speaker, and/or other components that may present information (e.g., a display, a screen, a lamp (LED), a graphical user interface (GUI), and/or even lighted keyboards) through visual, auditory, and/or other tactile cues.

Radio 1124 represents a radio that facilitates communication with a wireless telecommunications network. Illustrative wireless telecommunications technologies include CDMA, GPRS, TDMA, GSM, and the like. Radio 1124 might additionally or alternatively facilitate other types of wireless communications including Wi-Fi, WiMAX, LTE, 3G, 4G, LTE, mMIMO/5G, NR, VOLTE, or other VOIP communications. As can be appreciated, in various embodiments, radio 1124 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 1118 may take a variety of forms. Exemplary I/O ports may include a USB jack, a stereo jack, an infrared port, a firewire port, other proprietary communications ports, and the like. Input/output (I/O) components 1120 may comprise keyboards, microphones, speakers, touchscreens, and/or any other item usable to directly or indirectly input data into the computing device 1100.

Power supply 1122 may include batteries, fuel cells, and/or any other component that may act as a power source to supply power to the computing device 1100 or to other network components, including through one or more electrical connections or couplings. Power supply 1122 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for providing an anti-spam artificial intelligence service, the method comprising:
receiving a message at a user equipment (UE) corresponding to a user;
forwarding text corresponding to the message to an anti-spam engine to determine if the message is spam;
receiving, at the UE, a response from the anti-spam engine;
prompting the user, at the UE, to select an action to perform corresponding to the message.

2. The method of claim 1, wherein the action is to ignore, delete, or read the message.

3. The method of claim 1, wherein forwarding text corresponding to the message to an anti-spam engine comprises:
forwarding the text corresponding to the message to a server; and
instructing the server to make an application programming interface (API) call to the anti-spam engine, the API call including the text corresponding to the message.

4. The method of claim 1, further comprising receiving an indication, at the UE, the message is likely a scam message.

5. The method of claim 4, further comprising receiving a selection made by the user, at the UE, that causes the text corresponding to the message to be forwarded to the anti-spam engine.

6. The method of claim 4, further comprising receiving a selection made by the user, at the UE, that causes the text corresponding to the message to be forwarded to a cybersecurity service.

7. The method of claim 6, further comprising, upon the cybersecurity service being unable to determine if the text corresponding to the message is spam, causing the cybersecurity service to make an application programming interface (API) call to the anti-spam engine, the API call including the text corresponding to the message.

8. A non-transitory computer storage media storing computer-usable instructions that, when used by one or more processors, cause the one or more processors to perform operations, the operations comprising:
receiving a message at a user equipment (UE) corresponding to a user;
forwarding text corresponding to the message to an anti-spam engine to determine if the message is spam;
receiving, at the UE, a response from the anti-spam engine;
prompting the user, at the UE, to select an action to perform corresponding to the message.

9. The media of claim 8, wherein the action is to ignore, delete, or read the message.

10. The media of claim 8, wherein forwarding text corresponding to the message to an anti-spam engine comprises:
forwarding the text corresponding to the message to a server; and
instructing the server to make an application programming interface (API) call to the anti-spam engine, the API call including the text corresponding to the message.

11. The media of claim 8, further comprising receiving an indication, at the UE, the message is likely a scam message.

12. The media of claim 11, further comprising receiving a selection made by the user, at the UE, that causes the text corresponding to the message to be forwarded to the anti-spam engine.

13. The media of claim 11, further comprising receiving a selection made by the user, at the UE, that causes the text corresponding to the message to be forwarded to a cybersecurity service.

14. The media of claim 13, further comprising, upon the cybersecurity service being unable to determine if the text corresponding to the message is spam, causing the cybersecurity service to make an application programming interface (API) call to the anti-spam engine, the API call including the text corresponding to the message.

15. A system for providing an anti-spam artificial intelligence service, the system comprising:
a node configured to wirelessly communicate with a UE and an anti-spam engine;
the UE configured to:
(1) receive a message;
(2) forward text corresponding to the message to the anti-spam engine to determine if the message is spam;
(3) receive a response from the anti-spam engine; and
(4) prompt a user corresponding to the UE to select an action to perform corresponding to the message.

16. The system of claim 15, wherein the action is to ignore, delete, or read the message.

17. The system of claim 15, wherein forward text corresponding to the message to the anti-spam engine comprises:
forwarding the text corresponding to the message to a server; and
instructing the server to make an application programming interface (API) call to the anti-spam engine, the API call including the text corresponding to the message.

18. The system of claim 15, further comprising receiving an indication, at the UE, the message is likely a scam message.

19. The media of claim 18, further comprising receiving a selection made by a user corresponding to the UE that causes the text corresponding to the message to be forwarded to the anti-spam engine.

20. The media of claim 18, further comprising receiving a selection made by a user corresponding to the UE that causes the text corresponding to the message to be forwarded to a cybersecurity service and, upon the cybersecurity service being unable to determine if the text corresponding to the message is spam, causing the cybersecurity service to make an application programming interface (API) call to the anti-spam engine, the API call including the text corresponding to the message.
